(19) United States
(12) Patent Application Publication
(10) Pub. No.: US 2009/0085869 A1
(43) Pub. Date: Apr. 2, 2009

(54) REMOTE CONTROL POINTING TECHNOLOGY

(75) Inventors: Galileo June Destura, Eindhoven (NL); Egbert Wouter Joghum Robers, Delft (NL); Maurice Herman Johan Draaijer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/282,682

(22) PCT Filed: Mar. 2, 2007
(86) PCT No.: PCT/IB07/50680

§ 371 Date: Sep. 12, 2008

(30) Foreign Application Priority Data
Mar. 15, 2006 (EP) 06111205.8

(51) Int. Cl. G06F 3/033

(52) U.S. Cl. 345/157

(57) ABSTRACT

Pointing device (2) comprising two light sources (X1,X2) symmetrically arranged along a first axis (X) and two light sources (Y1,Y2) symmetrically arranged along a second axis (Y) perpendicular to the first axis (X). The pointing device (2) is used in a system comprising a light detector (4) near a screen and calculation means to determine where a user is pointing the device in relation to the screen. The light sources point in substantially the same direction along a third axis (Z) perpendicular to the first axis (X) and second axis (Y). The pointing device comprising shielding means (6) for shielding more light emitted by one of the light sources than light emitted by the other light sources when the pointing device (2) is pointed away from the detector (4), wherein the shielding means (6) are arranged substantially symmetrically with respect to the light sources (X1,X2).

### BACKGROUND OF THE INVENTION

1. Technical Field

The present invention relates to remote control pointing technology in general and to a pointing device in particular.

The present invention also relates to a system comprising a pointing device.

2. Description of Related Art

For easy interaction between a user and interactive content point-and-click operations, typically using a computer mouse, are very common and accepted. Usually, these operations are performed close to the screen and require a flat surface or a device, which is either hard to use or very expensive.

On the other hand, for lean-back and relax applications, e.g. watching video and listening to music, the remote control (RC) is commonly used. It can also be observed that the number of RC buttons is growing rapidly due to the growing complexity of the applications it controls. This has led to discontent and confusion on the part of the users on which buttons to press for a specific application.

The current problem is being compounded by the convergence of the traditional lean-back applications with the PC applications with the internet being the backend supporting infrastructure. A dilemma arises with the convergence as both the lean back and PC world have different interaction means.

In order to deal with this problem remote control pointing technology has been developed. Using a remote control hand held device comprising a number of Infra Red (IR) light emitting diodes (LEDs) and a light detector near a screen it is possible to determine where a user is pointing the device in relation to the screen. This enables users to make point-and-click operations or make gestures that can be recognized in the vicinity of the screen.

The main drawbacks of some known systems with pointing devices are the complexity in construction, high cost, high calculation requirements and/or an immense modification of the receiving apparatus. Also some of the known systems have the problem that position-information has to be sent from the hand held device to the screen side (either by wire or wireless).

A first pointing device is disclosed in the patent U.S. Pat. No. 5,949,402. The pointing device comprises four LEDs pointing in the same direction. Two of the LEDs are symmetrically placed along a first axis. The other two LEDs are symmetrically placed along a second axis perpendicular to the first axis. A lens is used for directing the light emitted by each of the LEDs in a different direction. A light detector near the screen receives the light beam emitted by each of the LEDs. The pointing angles of the pointing device can be calculated by taking the ratios of the pulse amplitudes of the LEDs placed along the first axis and by taking the ratios of the pulse amplitudes of the LEDs placed along the second axis. These pointing angles can then be used to position a cursor on a display screen.

However, the use of a lens for directing the light of the LEDs in different directions renders the pointing device expensive. It also complicates the construction of such a device as the position and orientation of the LED with respect to the axis of the lens needs to be aligned.

A second pointing device is disclosed in the patent U.S. Pat. No. 5,023,943. The pointing device comprises three LEDs with different radiation patterns. The centrally placed LED is a reference LED. It is unshielded and has a relatively flat light intensity profile. A first one of the remaining two LEDs is partially shielded in a first direction. As a result, this LED has a different radiation pattern in this first direction than the reference LED and the other one of the remaining two LEDs. The other one of the remaining two LEDs is partially shielded in a second direction perpendicular to the first direction. As a result, this other one of the remaining LEDs has a different radiation pattern in this second direction than the reference LED and the first one of the remaining two LEDs. On the receiving side the light is detected. The pointing direction of the pointing device is determined using the difference of the light intensities received from the reference LED and the first one of the remaining two LEDs and using the difference of the light intensities received from the reference LED and the second one of the remaining two LEDs.

However, this pointing device has the drawback that its linearity depends heavily on the flatness of the light intensity profile of the reference LED.

It is an object of the invention to provide a pointing device, which is simple and cheap without having high construction complexity, calculation requirements, and/or the need of an immense modification of the receiving apparatus.

It is a further object of the invention to provide a pointing device having a good linearity.

### SUMMARY OF THE INVENTION

These and other objects of the invention are achieved by a pointing device according to independent claim 1. Favorable embodiments are defined by the dependent claims 2-18.

A pointing device is provided comprising at least two light sources, for example LEDs. The pointing device is adapted for use in a system comprising a light detecting arrangement for detecting light emitted by the pointing device and means for determining where the pointing device is pointed. The at least two light sources of the pointing device are substantially symmetrically placed along a first axis and point in substantially the same direction. The pointing device comprises shielding means for shielding more light emitted by one of the light sources than light emitted by the other light source when the pointing device is pointed away from the light detecting arrangement. According to the invention the shielding means are arranged substantially symmetrically with respect to the at least two light sources. The proposed device is cheap and only needs a single low-cost light detector at the receiving apparatus. It allows the receiving side to calculate the pointing angle of the pointing device with respect to the light detector in a first direction. This pointing angle can be translated into a position in this first direction on a screen. Furthermore, the calculation requirements at the receiving side are low, which makes the system fast. Finally, the substantially symmetrical shielding of the at least two light sources facilitates easy signal normalisation at the receiver side, which makes it easy to compensate for user distance or bad light conditions.

According to an embodiment, the shielding means comprise two shielding walls which, seen in the direction of the first axis, are placed around the at least two light sources, the walls extending in the direction of a second axis perpendicular to the first axis.

In an alternative embodiment, the shielding means comprise a shielding wall placed between the at least two light sources, the wall extending in the direction of the second axis perpendicular to the first axis.

In both these embodiments the shielding means are kept very simple and at the same time have good properties.

Preferably, at the edges of the one or more shielding walls as seen in the pointing direction of the at least two light sources, a shielding member is arranged extending in the direction of the first axis. As a result thereof, there is already significant light shielding when the pointing device is only slightly pointed away from the detector. This allows a better detection of small movements of the pointing device.

According to a further embodiment the pointing device comprises at least two further light sources substantially symmetrically placed along the second axis, which is perpendicular to the first axis. The shielding means are arranged substantially symmetrically with respect to the at least two further light sources. This allows the receiving side to calculate the pointing angle of the pointing device with respect to the light detector in a second direction perpendicular to the first direction. This pointing angle can be translated into a position in the second direction on a screen.

Preferably, the shielding means have the shape of a square cavity. This allows a good separation of the movement in the first direction and the movement in the second direction. Furthermore, the square cavity allows for easy interpretation of the normalized pointing angle and the consequent translation towards screen position.

According to a further embodiment the at least two light sources of the pointing device substantially symmetrically placed along the first axis are adapted for emitting light with a different polarization than the at least two further light sources substantially symmetrically placed along the second axis. This is preferably achieved by equipping the at least two light sources of the pointing device placed along the first axis with a different polarizing filter than the at least two light sources placed along the second axis. In this way, if the receiving side is also equipped with a polarizing filter, it is possible to detect received signal strengths as a function of the roll, the rotation of the pointing device around its longitudinal axis. This allows quantification of the roll error and compensation of this error so that undesired roll effects when pointing in certain directions can be compensated. Alternatively, the roll of the pointing device may be used as an extra degree of freedom in control.

Preferably, the at least two light sources of the pointing device placed along the first axis are equipped with a horizontal polarizing filter and the at least two light sources placed along the second axis are equipped with a diagonal polarizing filter. In this way, the roll of the pointing device may be detected over an angle of 180°.

The light sources may be adapted to use time multiplexing. In this case, the light detector at the receiving side detects the light signals emitted by the light sources one after the other at the same frequency allowing a simple structure.

Alternatively or additionally, the light sources are adapted to use frequency, code or wavelength multiplexing. The use of frequency, code or wavelength multiplexing allows the use of additional signals, like a regular RC command at a different frequency, code or wavelength, totally different from the ones used to determine the pointed position. It also allows a fast position update speed as all the signals of the light sources can be detected at the same time. Furthermore, it facilitates the possibility of multiple pointing devices being used at the same time.

In a further preferred embodiment the pointing device comprises diffusing means for diffusing the light emitted by the light sources. The diffusing means smoothens the intensity profile of the light sources in the angle of movement. This allows the use of cheap LEDs with a non-smooth intensity profile, as light sources.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawing, in conjunction with the accompanying specification, in which:

FIG. 1 shows a first embodiment of the pointing device without its shielding means.

FIG. 2 shows the pointing device according to the first embodiment with its shielding means.

FIG. 3 shows a top cross-sectional view of a pointing device pointed to a light detector.

FIG. 4 shows a top cross-sectional view of the pointing device when pointed away from the light detector.

FIG. 5 shows a front view of the pointing device according to the first embodiment.

FIG. 6 shows a block diagram of the light detector and the signal processing means at the receiving end.

FIG. 7 shows a front view of the pointing device according to a second embodiment.

FIG. 8 shows a front view of the pointing device according to a third embodiment.

FIG. 9 shows a front view of the pointing device according to a fourth embodiment.

FIG. 10 shows a front view of the light sources equipped with polarizing filters.

FIG. 11 shows the light strength as a function of the roll angle of the pointing device with the structure according to FIG. 10.

Throughout the figures like reference numerals refer to like elements.

### DETAILED DESCRIPTION OF THE PRESENT INVENTION

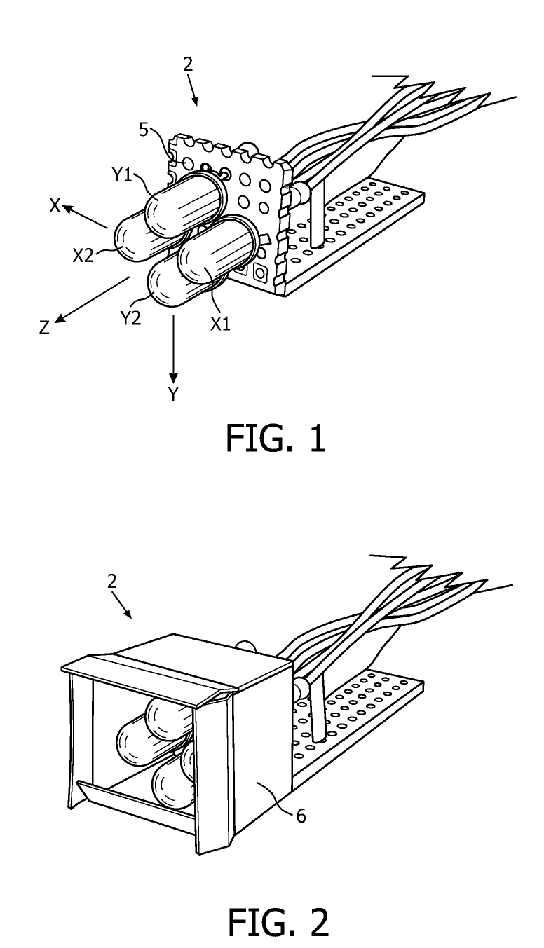

FIG. 1 shows the pointing device 2 without its shielding means. It has four symmetrically arranged light sources, for example LEDs which are placed on a substrate 5. Two of the LEDs X1,X2 are placed symmetrically along a first, horizontal axis X. The other two LEDs Y1,Y2 are placed symmetrically along a second, vertical axis Y. The LEDs all point substantially in the same direction, along a third axis Z, which is perpendicular to the first and the second axis.

The four light sources transmit modulated signals. This can be done by using frequency multiplexing (different flashing frequencies for each light source), code multiplexing (different orthogonal codes), wavelength multiplexing (different wavelengths) or a time division multiplexing technique (different flashing times).

As shown in FIG. 2 according to a first embodiment, the shielding means 6 have the shape of a squared cavity which is placed symmetrically around the four LEDs. The walls of the squared cavity slightly surpass the LEDs in the direction of the Z-axis. This is necessary for shielding a part of the light emitted, if the pointing device is pointed away from a light detector.

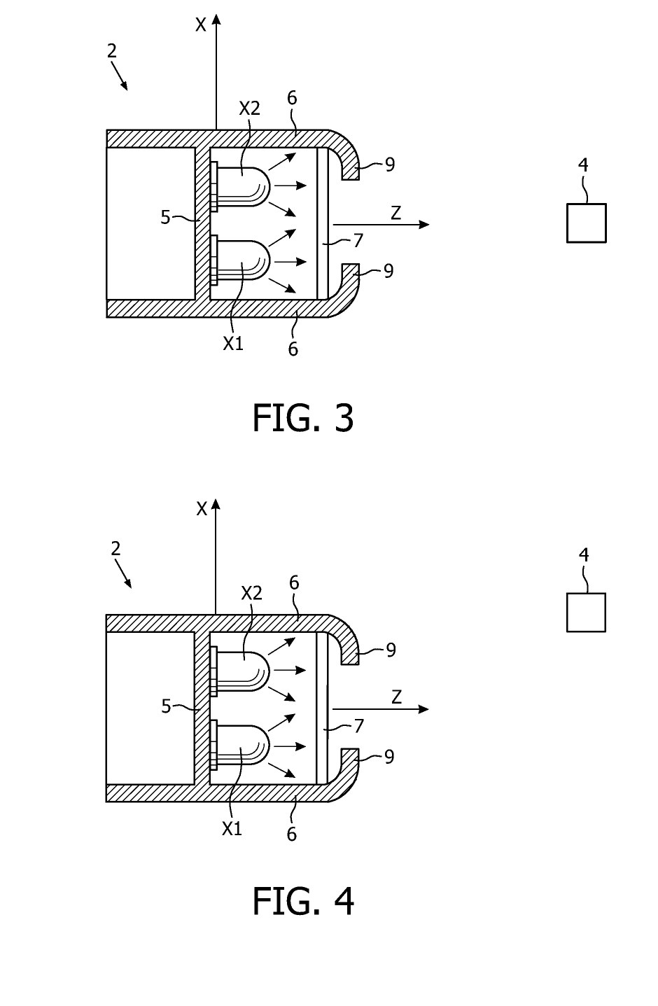

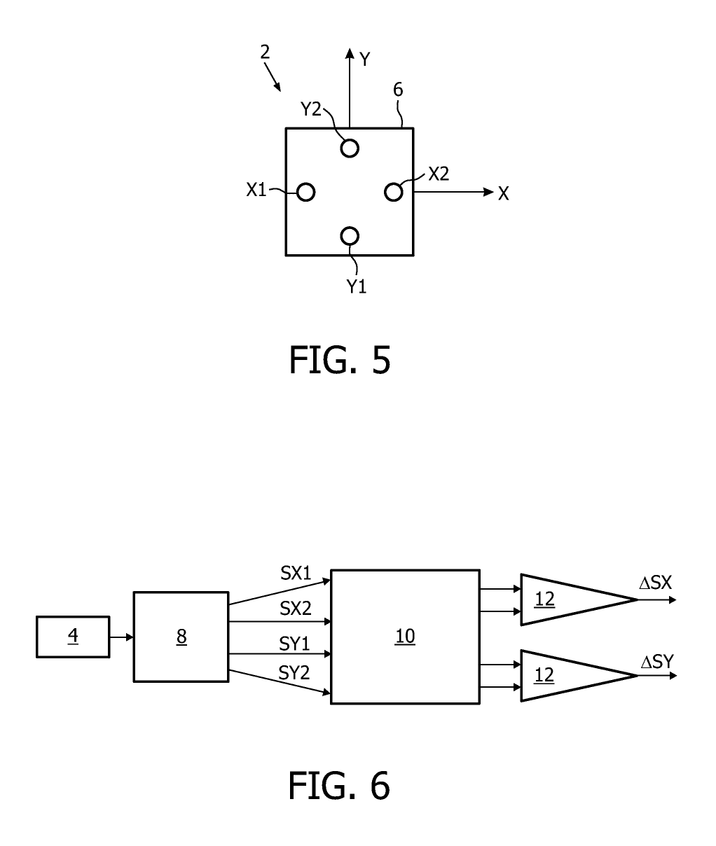

FIG. 3 shows a top cross-sectional view of the pointing device depicted in FIG. 2 when it is directed to a standard single light detector 4 for example a photo diode like to the ones used for (TV) infrared remote control. The pointing device 2 optionally comprises a common optical diffuser 7, resulting in relatively smooth and almost identical intensity patterns of the light sources. When the light sources in the cavity are pointed towards a light detector, the light detector 4 receives substantially equal light signals from all sources. The shielding means 6 consist of four rectangular walls placed next to the light sources and extending parallel to the light sources in the direction of the Z-axis. Preferably, at the front edge of the walls (seen in the direction of the Z-axis) a small shielding member 9 is arranged extending in the direction of the X-axis. So, a small part of the shielding means 6 is placed in front of the light sources. As shown in FIG. 4, when the light sources in a cavity are pointed slightly away from the detector one or two light sources are shielded more by the cavity edges as compared to the other light sources. Then the signal intensity of these light sources that are shielded more, received by the detector is reduced. In the configuration according to FIG. 4 the signal intensity of the light source X2 as received by the detector 4 is reduced FIG. 5 shows a front view of the pointing device depicted in FIG. 2.

As shown in FIG. 6, at the receiving end the signals SX1,SX2,SY1,SY2 emitted by the light sources X1,X2,Y1,Y2, respectively are separated by a signal separation filter 8. In the case of frequency multiplexed signals this can be done by using band filters for each signal. In the case of time division multiplexing the signals can be separated by a timer. In the case of code division multiplexing the signals are separated by using suitable decoders. In the case of wavelength multiplexing a corresponding detector 4 is needed for each wavelength used.

Then signal strength determining means 10 determine the signal strengths of the four signals. That can be achieved by using a rectifier followed by a low-pass filter for each signal.

Then signal difference determining means 12 determine the difference ASX between the signals SX1,SX2 emitted by the two horizontally placed light sources X1,X2 and the difference ASY between signals SY1,SY2 emitted by the two vertically placed light sources Y1,Y2.

The difference ASX determines the position where the user is pointing in a first direction. The difference ASY determines the position where the user is pointing in a second direction.

The difference signal can be normalized to compensate for user distance using the most powerful signal. In this way the system does not rely on signal strength, but on difference in signal strength making it less sensitive for environmental (background) light conditions. Also a changing user position hardly influences the system.

If the cavity walls are square, the Y-coordinate signal is not influenced by the X-movement and vice versa. Furthermore, the square cavity allows for easy interpretation of the normalized pointing angle and the consequent translation towards screen position.

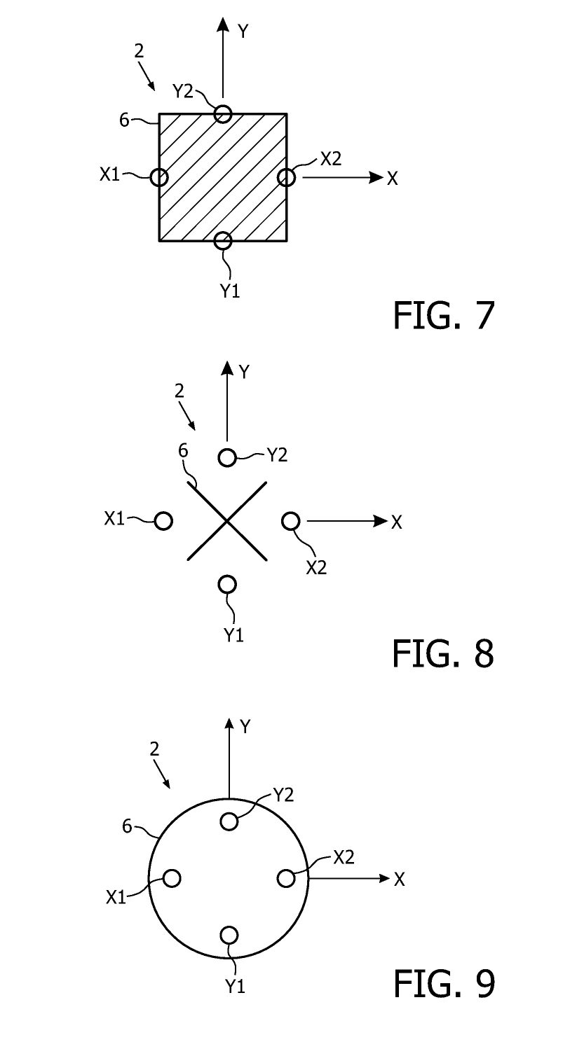

As shown in FIG. 7 according to a second embodiment the shielding means 6 of the pointing device 2 consist of a shield, extending in the direction of the X-axis and the Y-axis, which is placed in front of the light sources as seen in the direction of the Z-axis. Around the shield there is a free space for the transmission of light from the light sources in the direction of the detector 4.

As shown in FIG. 8 according to a third embodiment the shielding means 6 of the pointing device 2 consist of two walls placed between the four light sources. The walls extend diagonally under an angle of 45° with respect to both the X-axis and the Y-axis and are mutually perpendicular.

As shown in FIG. 9 according to a fourth embodiment the shielding means 6 of the pointing device 2 are circle shaped and placed symmetrically around the four light sources.

Preferably, the shielding means 6 of the pointing devices according to the third and fourth embodiment comprise a small shielding member 9 at the front edge of the walls (seen in the direction of the Z-axis). The shielding member extends in the direction of the X-axis, as described herein above.

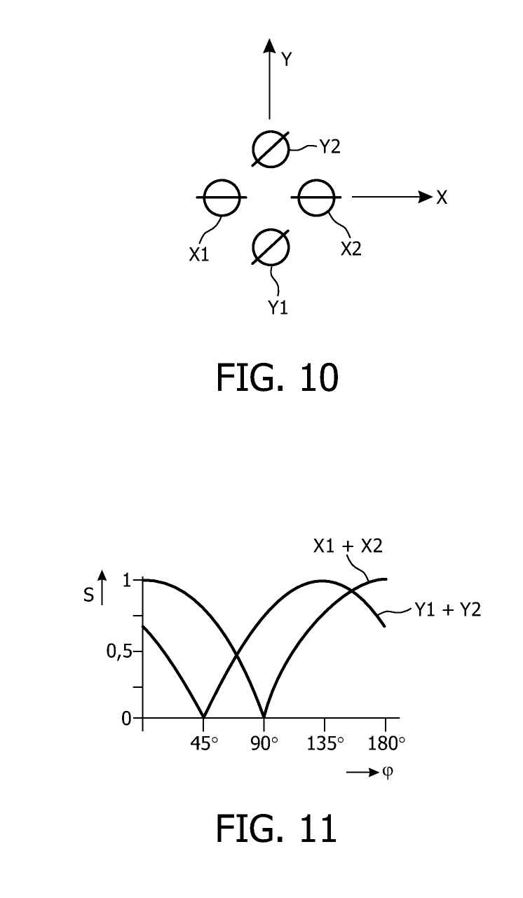

As shown schematically in FIG. 10, the light sources X1,X2 placed along the horizontal axis X emit horizontally polarized light. This may be achieved by equipping them with a horizontal polarizing filter. The light sources Y1,Y2 placed along the vertical axis Y emit diagonally polarized light. This may be achieved by equipping them with a diagonal polarizing filter. At the detector side (for instance a television set equipped with a light sensitive detector including a polarizing filter in horizontal orientation in the frequency range of the light emitting sources) the detected signal strength S varies as a function of roll φ (the rotation of the pointing device around the Z-axis), as depicted in FIG. 11. In this way, the roll of the pointing device may be detected over an angle of 180°. Of course, also polarizing filters with different angles than the ones shown in FIG. 10 may be used. It is, however, preferred to use polarization filters for the light sources along the horizontal axis X and vertical axis Y that differ by an angle, which is not equal to 90°. If polarization filters with an angle that differs by 90° are used, the roll angle can only be detected over an angle of 90° and not over an angle of 180°.

In the example above 100% efficient light blocking polarizing filters are used. However, in practice it is preferred to use substantially less than 100% efficient filters. In this way the “dips” in FIG. 11 will never becomes zero or close to zero which could make the system instable.

The pointing device can be used for numerous applications such as:
Remote control of a TV.
Control of devices that are connected to a display.
Control of various appliances like a lighting fixture.
Control of other devices by gesturing (e.g. changing volume by moving up or down).

As will be recognized by those skilled in the art, the innovative concepts described in the present application can be modified and varied over a wide range of applications. For example, although the light sources described herein are light emitting diodes emitting infra red light, any other light sources may be used, including light sources emitting visible light. Furthermore, alternative shapes of the shielding means may be used as long as they are symmetrically arranged with respect to the light sources. Finally, the number of light sources used may be higher than four.

Accordingly, the scope of patented subject matter should not be limited to any of the specific exemplary teachings discussed, but is instead defined by the following claims. Any reference signs in the claims shall not be construed as limiting the scope.

1. Pointing device (2) comprising at least two light sources (X1,X2), the pointing device (2) being adapted for use in a system comprising a light detecting arrangement (4) for detecting light emitted by the pointing device (2) and means for determining where the pointing device (2) is pointed, the at least two light sources (X1,X2) of the pointing device (2) being substantially symmetrically placed along a first axis (X) and pointing in substantially the same direction (Z), the pointing device (2) comprising shielding means (6) for shielding more light emitted by one of the light sources than light emitted by the other light source when the pointing device (2) is pointed away from the light detecting arrangement (4), wherein the shielding means (6) are arranged substantially symmetrically with respect to the at least two light sources (X1,X2).

2. Pointing device (2) according to claim 1 wherein the shielding means (6) comprise two shielding walls which, seen in the direction of the first axis (X), are placed around the at least two light sources (X1,X2), the walls extending in the direction of a second axis (Y) perpendicular to the first axis (X).

3. Pointing device (2) according to claim 1 wherein the shielding means (6) comprise a shielding wall placed between the at least two light sources (X1,X2), the wall extending in the direction of a second axis (Y) perpendicular to the first axis (X).

4. Pointing device (2) according to claim 2 wherein at the edges of the one or more shielding walls, seen in the pointing direction (Z) of the at least two light sources (X1,X2), a shielding member (9) is arranged extending in the direction of the first axis (X).

5. Pointing device (2) according to claim 1 wherein the pointing device (2) comprises at least two further light sources (Y1,Y2) substantially symmetrically placed along the second axis (Y), which is perpendicular to the first axis (X).

6. Pointing device (2) according to claim 5 wherein the shielding means (6) are arranged substantially symmetrically with respect to the at least two further light sources (Y1,Y2).

7. Pointing device (2) according to claim 6 wherein the shielding means (6) have the shape of a square cavity.

8. Pointing device (2) according to claim 5, wherein the at least two light sources (X1,X2) of the pointing device substantially symmetrically placed along the first axis (X) are adapted for emitting light with a different polarization than the at least two further light sources (Y1,Y2) substantially symmetrically placed along the second axis (Y).

9. Pointing device (2) according to claim 8 wherein the at least two light sources (X1,X2) of the pointing device (2) substantially symmetrically placed along the first axis (X) are equipped with a different polarizing filter than the at least two light sources (Y1,Y2) of the pointing device (2) substantially symmetrically placed along the second axis (Y).

10. Pointing device (2) according to claim 9 wherein the at least two light sources (X1,X2) of the pointing device (2) substantially symmetrically placed along the first axis (X) are equipped with a horizontal polarizing filter and the at least two light sources (Y1,Y2) of the pointing device (2) substantially symmetrically placed along the second axis (Y) are equipped with a diagonal polarizing filter.

11. Pointing device (2) according to claim 1 wherein the light sources are adapted to use time multiplexing.

12. Pointing device (2) according to claim 1 wherein the light sources are adapted to use frequency multiplexing.

13. Pointing device (2) according to claim 1 wherein the light sources are adapted to use code multiplexing.

14. Pointing device (2) according to claim 1 wherein the light sources are adapted to use wavelength multiplexing.

15. Pointing device (2) comprising at least two light sources (X1,X2) the pointing device (2) being adapted for use in a system comprising a light detecting arrangement (4) for detecting light emitted by the pointing device (2) and means for determining where the pointing device (2) is pointed, the at least two light sources (X1,X2) of the pointing device (2) being substantially symmetrically placed along a first axis (X) and pointing in substantially the same direction (Z), the pointing device (2) comprising shielding means (6) for shielding more light emitted by one of the light sources than light emitted by the other light source when the pointing device (2) is pointed away from the light detecting arrangement (4), wherein the shielding means (6) are arranged substantially symmetrically with respect to the at least two light sources (X1,X2) wherein the light sources are adapted to use any combinations of the multiplexing schemes as described in claim 11.

16. Pointing device (2) according to claim 1 comprising diffusing means (7) for diffusing the light emitted by the light sources.

17. Pointing device (2) according to claim 1 wherein the pointing device is a remote control.

18. System comprising a pointing device (2) according to claim 1, a light detecting arrangement (4) for detecting light emitted by the pointing device (2) and means for determining where the pointing device (2) is pointed.
